(19) United States
(12) Patent Application Publication
(10) Pub. No.: US 2012/0054115 A1
(43) Pub. Date: Mar. 1, 2012

(54) SOCIAL NETWORK SUPPORTING MANAGEMENT OF POSTS TO FOLLOWERS

(76) Inventors: Anselm P. Baird-Smith, San Jose, CA (US); Payam Mirrashidi, San Francisco, CA (US); Steve S. Gedikian, Redwood City, CA (US)

(21) Appl. No.: 13/216,170

(22) Filed: Aug. 23, 2011

Related U.S. Application Data
(60) Provisional application No. 61/378,839, filed on Aug. 31, 2010.

(51) Int. Cl. G06Q 99/00

(52) U.S. Cl. 705/319

(57) ABSTRACT

Embodiments of enhancements to online social networks are disclosed. According to one aspect, methods and systems described herein can facilitate and manage “posts” amongst followers. The posts can be user-initiated or system-initiated. In one embodiment, system-initiated posts can occur when a follower performs a commerce event. The enhanced online social network can be integrated or coupled with an electronic commerce site (e.g., online store). As such, purchases at the electronic commerce site can be used to inject commerce related posts to followers' feeds. In another embodiment, for a given user, posts to a user's feed can be managed to limit or filter posts so that those posts being posted are more likely to be of interest to the given user.

### CROSS-REFERENCE TO RELATED APPLICATION

This application claims priority to U.S. Provisional Patent Application No. 61/378,839, filed Aug. 31, 2010, entitled “NETWORKED SYSTEM FOR SUPPORTING MEDIA ACCESS AND SOCIAL NETWORKING,” and incorporated herein by reference for all purposes.

### BACKGROUND OF THE INVENTION

In recent times, social networks have become popular. Social networks allow social interaction online amongst users located anywhere in the world. Typically, in a social networking system, users have a user page that can be accessible to other users. Furthermore, in some social networking systems, one user can “follow” another user. Typically, when one or more users follow another user, “posts” provided by the followed user can be presented to all the followers of the followed user. The “posts” can be presented as a status update, a location, a mood/feeling, or a thought provided by the user. In some systems, location status can be updated automatically. As social networks become more popular, “following” a significant number of other users can result in a user receiving excessive “posts”. This can result in a user missing or ignoring “posts” that are important or of interest to the user.

Thus, there is a need for improved techniques to facilitate and manage providing information to followers in a social networking environment.

### SUMMARY

Embodiments of the invention disclosed herein pertain to enhanced online social networks. According to one aspect, methods and systems being described can facilitate and manage “posts” amongst followers. The posts can be user-initiated or system-initiated. In one embodiment, system-initiated posts can occur when a follower performs a commerce event. The enhanced online social network can be integrated or coupled with an electronic commerce site (e.g., online store). As such, purchases at the electronic commerce site can be used to inject commerce related posts to followers' feeds. In another embodiment, for a given user, posts to a user's feed can be managed to limit or filter posts so that those posts being posted are more likely to be of interest to the given user.

The invention can be implemented in numerous ways, including as a method, system, device, apparatus (including computer readable medium and graphical user interface). Several embodiments of the invention are discussed below.

As a method for managing distribution of user activity over a data network, one embodiment of the method can, for example, include at least the operations of processing a commerce transaction with an online store for a first user, creating an activity post based on the commerce transaction, and posting the activity post to an online user page for the first user. The method can also include the operations of determining one or more followers of the first user that are to be made aware of the commerce transaction of the first user, creating a followed commerce post for the commerce event of the user, and posting the followed commerce post to the follower page for at least one of the determined one or more followers.

As an online activity monitoring and distribution system, one embodiment of the system can, for example, include a plurality of users with each user having at least one electronic page, where one or more of the users follow one or more other of the users. The system can further include at least one server computer configured to provide electronic pages for each of the users. The at least one server computer supporting an activity event manager to manage activity of the users. The activity event manager is configured to receive activity events for the users and, for each the activity events being received regarding a particular user, the activity event manager can (i) determine those other users that respectively follow the particular user, (i) form a followed activity post based on the activity event received regarding the particular user, and (iii) send the followed activity post to the electronic pages corresponding to the other users that respectively follow the particular user.

As a computer readable medium including at least computer program code tangibly stored thereon for managing distribution of user activity over a data network, the computer readable medium includes at least computer program code for detecting an electronic commerce transaction for a product or service for a first user, computer program code for determining at least one follower of the first user that is to be made aware of the commerce transaction of the first user, computer program code for creating a followed commerce post for the commerce transaction of the user, and computer program code for posting the followed commerce post to the follower page for the determined at least one follower.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a social activity following system according to one embodiment.

FIG. 2 is an illustrative diagram of a user page according to one embodiment.

FIG. 3A is a user page according to one embodiment.

FIG. 3B is a user page according to another embodiment.

FIG. 4 is a connection page according to one embodiment.

FIG. 5A is a block diagram of an event processing system according to one embodiment.

FIG. 5B is a block diagram of an event processing system according to another embodiment.

FIGS. 6A and 6B are flow diagrams of a commerce posting process according to one embodiment.

FIG. 7 is a flow diagram of a followed activity posting process according to one embodiment.

FIG. 8 illustrates a block diagram of a computing device according to one embodiment.

### DETAILED DESCRIPTION OF EMBODIMENTS OF THE INVENTION

Embodiments of the invention disclosed herein pertain to enhanced online social networks. According to one aspect, methods and systems being described can facilitate and manage “posts” amongst followers. The posts can be user-initiated or system-initiated. In one embodiment, system-initiated posts can occur when a follower performs a commerce event. The enhanced online social network can be integrated or coupled with an electronic commerce site (e.g., online store). As such, purchases at the electronic commerce site can be used to inject commerce related posts to followers' feeds. In another embodiment, for a given user, posts to a user's feed can be managed to limit or filter posts so that those posts being posted are more likely to be of interest to the given user.

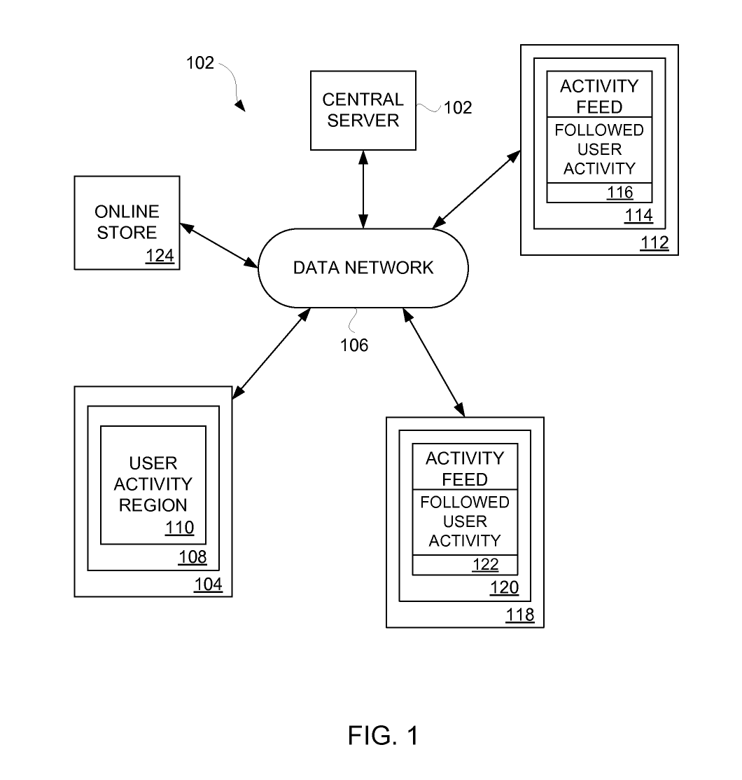

Several embodiments of the invention are discussed below with reference to FIGS. 1-8. However, those skilled in the art will readily appreciate that the detailed description given herein with respect to these figures is for explanatory purposes as the invention can extend beyond these limited embodiments.

FIG. 1 is a block diagram of a social activity following system 100 according to one embodiment. The social activity following system 100 includes a central server 102. The central server 102 includes one or more processing units to perform computer program code stored on one or more data storage devices. The central server 102 can also store profile and other information pertaining to a plurality of users. Users of the social activity following system 100 can follow access their profile as well as profiles other users. Additionally, users of the social activity following system 100 can allow users to follow other users. Still further, the social activity following system 100 can provide recommendations of other users that one might be interested in following.

The social activity following system 100 also supports a plurality of user computers that can be associated with users. In particular, the social activity following system 100 illustrates a user computer 104 that can couple to a data network 106. The central server 102 is also coupled to the data network 106. The user computer 104, though interaction with the central server 102, is capable of presenting a user page 108. For example, the user computer 104 can include a display that is capable of presenting the user page 108. According to one embodiment, the user page 108 can include a user activity region 110. The user activity region 110 can present an activity feed within the user activity region 110.

The social activity following system 100 can also support a plurality of follower computers that can be associated with users that follow other users. In the example illustrated in FIG. 1, there are two followers of the user associated with the user computer 104. Specifically, the social activity following system 100 can support a follower computer 112 having a display capable of presenting a follower page 114. The follower page 114 can include an activity feed 116. The activity feed 116 can, among other things, include followed user activity. As an example, the followed user activity being presented in the activity feed 116 can pertain to the user activity associated with at least the user of the user computer 104. However, typically, the followed user activity being presented in the activity feed 116 can pertain to the user activity associated with the user of the user computer 104 as well as user activity associated with various other users also being followed. Additionally, the social activity following system 100 can support a follower computer 118 having a display capable of presenting a follower page 120. The follower page 120 can include an activity feed 122. The activity feed 122 can, among other things, include followed user activity. As an example, the followed user activity being presented in the activity feed 122 can pertain to at least the user activity associated with the user of the user computer 104. In another example, the followed user activity being presented in the activity feed 122 can pertain to the user activity associated with the user of the user computer 118 as well as user activity associated with various other users also being followed.

More generally, the user page 108 as well as the follower pages 114, 120 are electronic pages. The user computer 104 receives the electronic page for the user page 108 from the central server 102, and then presents the electronic page on the display of the user computer 104. The follower computers 112, 118 respectively receive electronic pages for the follower pages 114, 120, and then respectively present the electronic pages on the displays of the follower computers 112, 118.

The central server 102 can manage the activity feeds for the various users, including followers. That is, when the user activity feed within user activity region 110 is updated (e.g., by including a new activity posting), the updated user activity can also propagate to the followers of the user. In such case, the corresponding follower pages 114, 120 can be updated to include followed user activity corresponding to the updated user activity within the activity feeds 112, 122. However, it should be noted that a follower typically follows a plurality of different users. As such, the activity feeds presented on a follower page typically integrate activity from a plurality of different users as well as activity associated with the corresponding follower (user).

The social activity following system 100 can also support an online store 124. The user can interact with the online store 124 to engage in e-commerce transactions to purchase products or services. In one embodiment, the online store 124 can facilitate purchase of electronic products (or digital assets), such as digital media or software programs. As one example, the online store 124 can pertain to an online media store from which users can purchase numerous media items. As another example, the online store 124 can pertain to an online application store from which users can purchase numerous application programs. As discussed in detail below, if a purchase occurs from the online store 124 by the user, an activity event can be produced. The activity event can be inserted into the user activity region 110 of the user page 108. The central server 102 can also propagate or provide the activity event of the user to those of the followers of the user. Consequently, the follower pages 114, 120 of the follower pages 112, 118 can receive the activity event associated with the user cause an activity post to be presented in the activity feed associated with the follower pages 114, 120.

Although the central server 102 and the online store 124 are depicted in FIG. 1 as being separate devices, it should be understood that the central server 102 and the online store 124 can both be hosted on the same device (e.g., server).

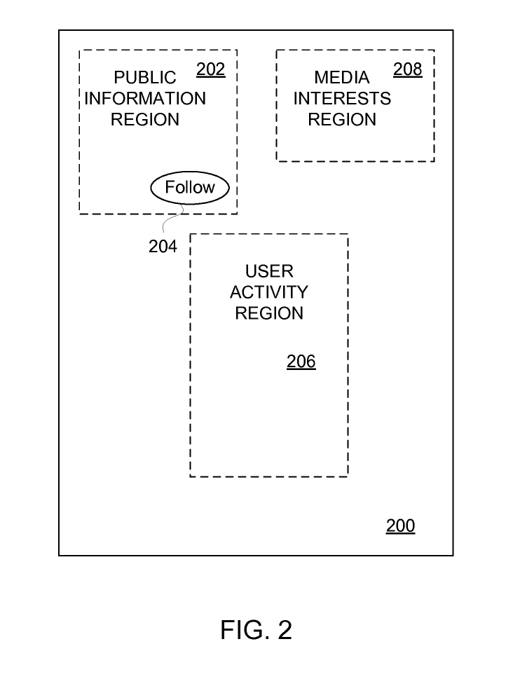

FIG. 2 is an illustrative diagram of a user page 200 according to one embodiment. The user page 200 can, for example, represent one implementation of the user page 108 illustrated in FIG. 1.

The user page 200 can include a public information region 202 that can include information descriptive of the user. The public information region 202 can be publicly accessible by any user. The user page 200 can also include a user control 204 to request to follow the user associated with the user page 200. Additionally, the user page 200 can include a user activity region 206. The user activity region 206 can be controlled such that it is visible to only authorized users. For example, the user activity region 206 would be visible to (i) the user associated with the user page 200, and (ii) followers of the user (which have implicitly or explicitly been authorized to view the user activity region 206). Still further, the user page 200 and can include a media interest region 208. The media interest region 208 can identify one or more media assets or characterize media interests to thereby provide information to other users regarding the media interests of the user corresponding to the user page 200. The media interests can pertain to one or more different types of media assets, including songs, collection of songs (e.g., albums), movies, images, podcasts, electronic books, games or applications. More generally, media assets can be denoted as digital assets, though since most digital assets which have a media aspect, the digital assets are also typically media assets.

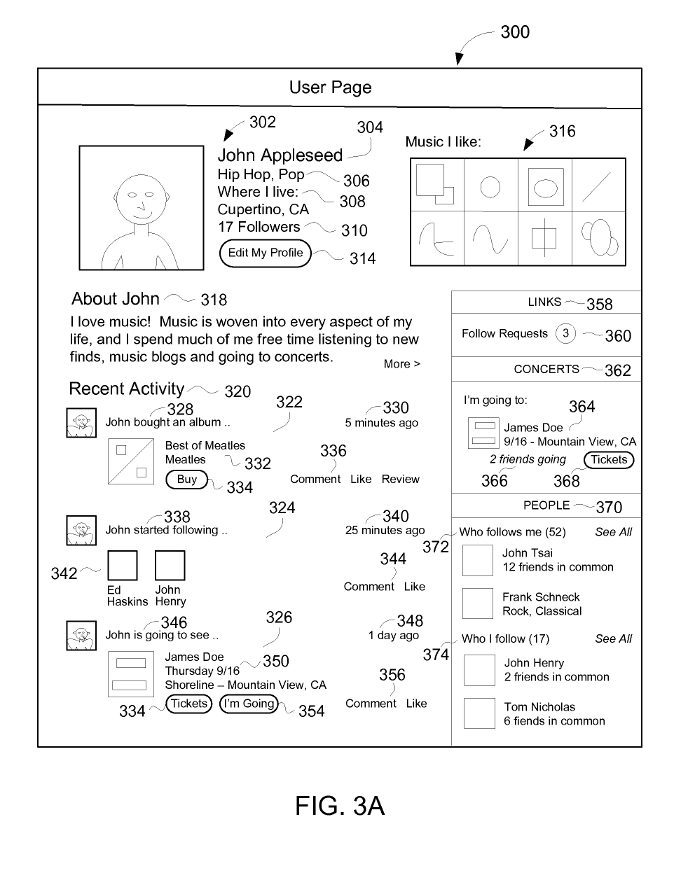

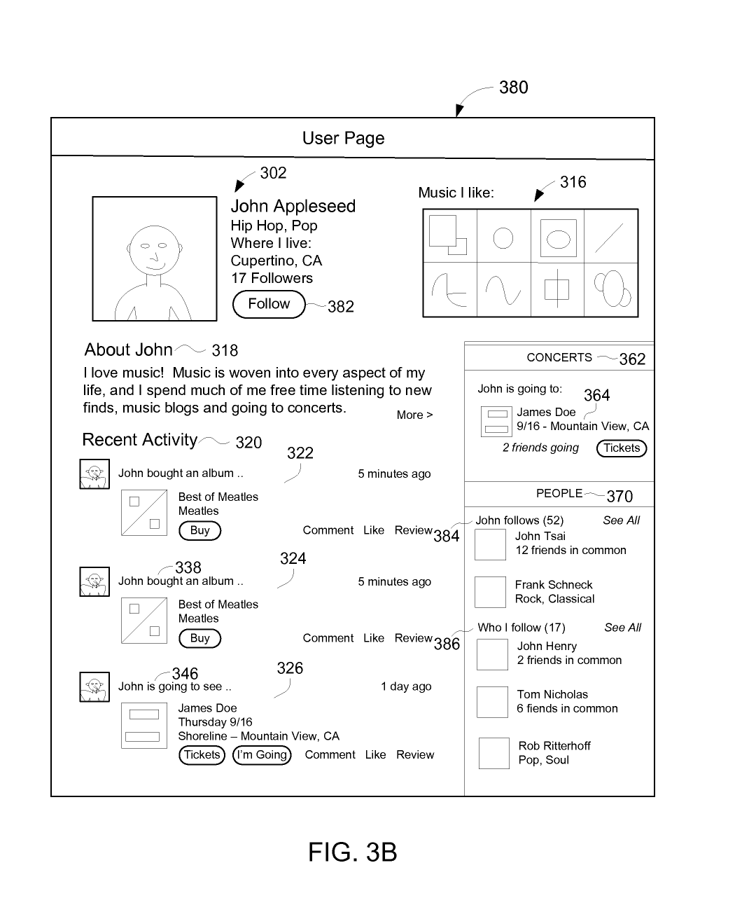

FIG. 3A is a user page 300 according to one embodiment. The user page 300 pertains to a particular user of the users of a social network system, such as the social activity following system 100. The user page 300 can represent a user page for a user when being viewed by that user. The user page 300 can represent a user page of the social activity following system 100 illustrated in FIG. 1. For example, in one implementation, the user page 300 can be an electronic page that is provided by the central server 102 to the user computer 104 for display.

The user page 300 can be presented to the particular user. In this embodiment, the user page 300 is the user page for the particular user. The user page 300 includes a user section 302 that provides basic description (i.e., profile) for the user. As illustrated in FIG. 3A, the user section 302 can include a name 304, music genres of interest 306, where the user lives 308, number of followers 310, and an associated image 312. In addition, the user section 302 can include a user control 314 that allows the user to edit the user's profile.

The user page 300 can also include an “I like” section 316. Here, the user can depict digital assets, namely, digital media assets, that they like. For example, as illustrated in FIG. 3A, the digital media assets can pertain to music and representations of selected albums can be represented. In the specific example illustrated in FIG. 3A, the “I like” section 316, there is a grid-like presentation of eight albums that represents the musical tastes (i.e., likes) of the user. The selection of the albums to be represented can be manually performed by the user or automatically performed by the system.

The user page 300 can also include an about section 318. In this example, the about section 318 is denoted “About John” since the particular user is named John. The about section 318 can include a description of the particular user. If an extensive description is provided, an initial portion of the description can be displayed with any remaining portion being accessible via “more” user control provided in or adjacent to the about section 318.

The user page 300 can also include a “recent activity” section 320. The recent activity section 320 can include recent activity associated with, in this case, the particular user. In the user page 300 shown in FIG. 3A, the recent activity section 320 includes three (3) distinct recent activities of the particular user. These distinct recent activities can be referred to as a first recent activity 322, a second recent activity 324, and a third recent activity 326.

The first recent activity 322 has an activity type description 320 that indicates that the particular user, i.e., John, recently bought an album. A timing indication 330 indicates that the album was, in this example, purchased five (5) minutes ago. The first recent activity 322 can also provide descriptive information 332 for the album that has been purchased. In this example, the descriptive information 332 can include the title of the album, the name of the artist, and a representative image (such as album cover art). Still further, the first recent activity 332 can include a user control 334 that facilitates purchase of the same album that was previously bought. The first recent activity 322 can also display user controls 336 that allow users to leave a comment, indicate that they like (or dislike) the purchase, or provide a review for the album.

The second recent activity 324 has an activity type description 338 that indicates that the particular user, i.e., John, recently started to follow one or more other users (e.g., people or artists). A timing indication 340 indicates that, in this example, the particular user starting follow the one or more other users twenty-five (25) minutes ago. The second recent activity 324 can also provide followed user information 342 to identify the one or more other users being now followed by the particular user. For example, the followed user information 342 can provide a name and an associated image for each of the newly followed users. The second user activity 324 can also display user controls 344 that allow users to leave a comment or indicate that they like (or dislike) the following of the newly followed users.

The third recent activity 326 has an activity type description 346 that indicates that the particular user, i.e., John, is going to see an event. In this example, the event is a concert but in general that event can be any event (though preferably a ticketed event). A timing indication 348 indicates that the particular user decided to go (or confirm he was going) to the event one (1) day ago. The third recent activity 326 can also provide descriptive information 350 for the concert. In this example, the descriptive information 350 can include the name of the artist, date and location for the concert and can also include a representative image (such as concert poster). Still further, the third recent activity 326 can include a user control 352 that facilitates purchase of tickets to the concert, and/or a user control 354 that enables a user to designate that they are going to the concert. The third user activity 326 can also display user controls 356 that allow users to leave a comment or indicate that they like (or dislike) the concert.

The user page 300 can also include a links section 358. In the links section 358 information concerning links or connections for the particular user of the user page 300 can be provided. As illustrated in FIG. 3A, the links section 358 can indicate to the particular user the number of outstanding follow requests 360 that have been received. In this example, the links section 358 indicates that the particular user has three (3) pending follow requests.

The user page 300 can also include a concert section 362. In the concert section 362, information concerning one or more concerts can be provided. The concerts are, however, concerts that the particular user has previously indicated that they are going. As illustrated in FIG. 3A, the concert section 362 indicates that the particular user is going to a particular concert. Concert information 364 can be provided in the concert section 362 to describe the particular concert. For example, the concert information 364 can include name of the artist, the date of the concert, the location of the concert, and perhaps a graphic associated with the artist or concert. In addition, the concert section 362 can provide a friends indication 366 that identifies those friends of the particular user that the system knows that are going to the same concert. In this example, the friends indication 366 denotes that “2 friends going”. Still further, the concert section 362 can provide a user control 368 that facilitates purchase of tickets to the particular concert.

The user page 300 can also include a people section 370. The people section 370 can provide abbreviated listings for people of the user follows or is followed by. The people section 370 can include a “who I follow” section 372 that can depict information on a subset of the other users that the particular user of the user page 300 follows. The people section 370 can also include a “who follows me” section 374 that can depict information on a subset of those other users that are currently following the particular user of the user page 300. The people section 370 can also include user controls (e.g., “See All”) that allow the user to see all of the people that the user follows or that follow the user.

FIG. 3B is a user page 380 according to another embodiment. The user page 380 pertains to a particular user of the users of a social network system, such as the social activity following system 100. The user page 380 can represent a connection page of the social activity following system 100 illustrated in FIG. 1. The user page 380 can represent a user page for a particular user when being viewed by another user that is not presently following the particular user.

The user page 380 can be presented to the another user. In this embodiment, the user page 380 is the user page for a particular user that the another user is interested in viewing (and possibly following). The user page 380 is generally similar to the user page 300 illustrated in FIG. 3A. There are, however, some differences. The user section 302 is generally the same; however, the user control 314 can be replaced with a user control 382 (e.g., “Follow” button). The user control 382 facilitates the another user in requesting to follow the particular user. The “I like” section 316, the about section 318, the “recent activity” section 320, and the concerts section 362 can all be same or similar to that described with reference to FIG. 3A. The links section 358 is removed from the user page 380 since such is inappropriate for the another user. The people section 370 is generally similar to that described with reference to FIG. 3A. However, one sub-sections in the people section 370 can be recast as “John follows” and can depict information on a subset of the other users that the particular user (i.e., John) of the user page 300 follows. The other sub-section in the people section 370 can be recast as “Who follows me” and can depict information on a subset of those other users that are currently following the particular user of the user page 300.

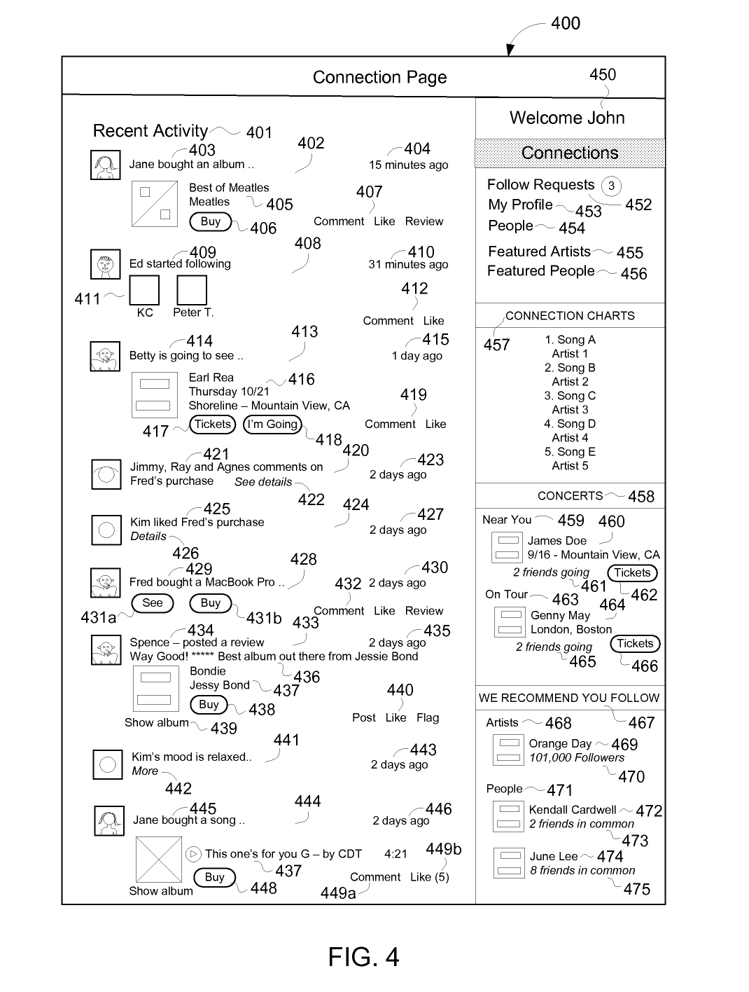

FIG. 4 is a connection page 400 according to one embodiment. The connection page 400 pertains to a particular user of the users of a social network system, such as the social activity following system 100. The connection page 400 can represent a page providing activity information concerning various other users that the particular user follows. The connection page 400 can represent a page provided by the social activity following system 100 illustrated in FIG. 1. For example, in one implementation, the connection page 300 can be an electronic page that is provided by the central server 102 to the user computer 104 for display. Also, since the connection page 400 is affiliated with a user, the connection page 400 can also be referred to as a user page.

The connection page 400 can be presented to the particular user. In this embodiment, the connection page 400 is a connection for the particular user. The connection page 400 provides information, such as activity information, concerning connections (e.g., other users that are followed) to the particular user.

The connection page 400 can include a “recent activity” section 401. The recent activity section 401 can pertain to an activity feed being presented by the connection page 400. The recent activity section 401 can include recent activity associated with those other users being followed by the particular user. In the connection page 400 shown in FIG. 4, the recent activity section 401 includes a plurality of distinct recent activities of various other users. These distinct recent activities can be presented in a list format with most recent activities at the top of the list. In one embodiment, more recent activities (e.g., activity events) of those users being followed can be noted towards the top portion of the recent activity section 401.

A first recent activity 402 has an activity type description 403 that indicates that a user, i.e., Jane, recently bought an album. A timing indication 404 indicates that the album was, in this example, was purchased fifteen (15) minutes ago. The first recent activity 402 can also provide descriptive information 405 for at the album that has been purchased. In this example, the descriptive information 405 can include the title of the album, the name of the artist, and a representative image (such as album cover art). Still further, the first recent activity 402 can include a user control 406 (e.g., “Buy” button) that facilitates purchase of the same album that was previously bought. The first recent activity 402 can also display user controls 407 that allow users to leave a comment, indicate that they like (or dislike) the purchase, or provide a review for the album.

A second recent activity 408 has an activity type description 409 that indicates that a user, i.e., Ed, recently started to follow one or more other users (i.e., KC and Peter T.). A timing indication 410 indicates that, in this example, the user starting follow these one or more other users thirty-one (31) minutes ago. The second recent activity 408 can also provide followed user information 411 to identify the one or more other users being now followed by the user (i.e., Ed). For example, the followed user information 411 can provide a name and an associated image for each of the newly followed users. The second user activity 408 can also display user controls 412 that allow users to leave a comment or indicate that they like (or dislike) the following.

A third recent activity 413 has an activity type description 414 that indicates that a user, i.e., Betty, is going to see an event. In this example, the event is a concert but in general that event can be any event (though preferably a ticketed event). A timing indication 415 indicates that the particular user decided to go (or confirm she was going) to the event one (1) day ago. The third recent activity 413 can also provide descriptive information 416 for the concert. In this example, the descriptive information 416 can include the name of the artist, date and location for the concert and can also include a representative image (such as concert poster). Still further, the third recent activity 413 can include a user control 417 (e.g., “Tickets” button) that facilitates purchase of tickets to the concert, and/or a user control 418 (e.g., “I'm Going” button) that enables a user to designate that they are going to the concert. The third user activity 413 can also display user controls 419 that allow users to leave a comment or indicate that they like (or dislike) the concert.

A fourth recent activity 420 has an activity type description 421 that indicates that users, i.e., Jimmy, Ray and Agnes, have recently commented on a posted purchase by another user (i.e., Fred). A “See details” user control 422 (e.g., link) allows access to the specific comments by Jimmy, Ray and Agnes. A timing indication 423 indicates that, in this example, the users commented two (2) days ago.

A fifth recent activity 424 has an activity type description 425 that indicates that a user, i.e., Kim, “liked” the purchase made by another user (i.e., Fred). A “Details” user control 426 (e.g., link) allows access to details of the post by Kim, if any. A timing indication 427 indicates that, in this example, the user commented two (2) days ago.

A sixth recent activity 428 has an activity type description 429 that indicates that a user, i.e., Fred, recently bought a product. In this example, the product is a MacBook Pro™, which is a laptop computer from Apple Inc. A timing indication 430 indicates that the product was, in this example, purchased two (2) days ago. Although not shown in FIG. 4, the sixth recent activity 428 could also provide descriptive information (e.g., text and/or image) for at the product that has been purchased. The sixth recent activity 428 can include a user control 431a (e.g., “See” button) that facilitates seeing the product that was previously bought (e.g., by accessing an image, slideshow or movie), and/or a user control 431b (e.g., “Buy” button) that facilitates purchase of the same product that was previously bought. The sixth recent activity 428 can also display user controls 432 that allow users to leave a comment, indicate that they like (or dislike) the purchase, or provide a review for the product.

A seventh recent activity 433 has an activity type description 434 that indicates that a user, i.e., Spence, posted a review on a product or event. In this example, the review pertains to an album. A timing indication 435 indicates that the review was posted two (2) days ago. The seventh recent activity 433 can include review content 436 that contains at least a portion of the review. If more review content is available beyond that displayed a “More” link (not shown) can be provided to access the additional review content. The seventh recent activity 433 can also include descriptive information 437 for the product or event. In this example, the descriptive information 437 can include the name of the album, the artist, and can also include a representative image (such as album cover art). Still further, the seventh recent activity 433 can include a user control 438 (e.g., “Buy” button) that facilitates purchase of the product, e.g., album, that has been reviewed. The seventh recent activity 433 can also include a user control 439 (e.g., “Show album” link) that enable the user to view additional information concerning the album (e.g., track list, etc.). The seventh recent activity 433 can also display user controls 440 that allow users to post the review, indicate that they like (or dislike) the review, or flag the review for editorial review.

A eighth recent activity 441 has an activity type description 442 that indicates that a user, i.e., Kim, has indicated her mood as “relaxed”. A “More” user control (e.g., link) allows access to access additional details of the mood of Kim, if any. A timing indication 443 indicates that, in this example, the user posted her mood two (2) days ago.

A ninth recent activity 444 has an activity type description 445 that indicates that a user, i.e., Jane, recently bought a song. A timing indication 446 indicates that the album was, in this example, was purchased two (2) days ago. The ninth recent activity 444 can also provide descriptive information 447 for at the song that has been purchased. In this example, the descriptive information 405 can include the name of the song, the name of the artist, and a representative image (such as album cover art). Still further, the ninth recent activity 444 can include a user control 448 (e.g., “Buy” button) that facilitates purchase of the same song that was previously bought. A further user control can also be provided to allow a user to initiate preview of the song. The ninth recent activity 444 can also display user controls 449a that allow users to leave a comment, or indicate that they like (or dislike) the purchase. In this example, adjacent the user controls 449a is an indication 449b that five (5) others have already indicated that they like the purchase.

The connection page 400 can also include a greeting 450 for the user, which in this example is “John”. The connection page 400 can also include a connection navigation section 451. In the connection navigation section 451, the user can navigate to other pages, such as via a Follow Requests page indicator 452, a My Profile page indicator 453, a People page indicator 454, a Featured Artists page indicator 455, and a Featured People page indicator 456. These indicators can, for example, be links. As illustrated in FIG. 4, adjacent the Follow Requests page indicator, the connections navigation section 451 can indicate to the user the number of outstanding follow requests that have been received. In this example, the connection navigation section 451 indicates that the particular user has three (3) follow requests.

The connection page 400 can also include a connection charts section 457. The connection charts section 457 can include at least one chart of songs. For example, the chart can be a list of songs that are most popular, most frequently played, or most common amongst one's social network, etc. The connection charts section 457 shows a chart including five (5) songs.

The connection page 400 can also include a concert section 458. In the concert section 458, information concerning one or more concerts can be provided. The concerts are those that may be of interest to the user. The concerts section 458 includes a “Near You” section 459 where concerts near the user can be identified. As illustrated in FIG. 4, the Near You section 459 indicates that there is an upcoming concert in the geographic area of the user. Concert information 460 can be provided in the Near You section 459 to describe the particular concert. For example, the concert information 460 can include name of the artist, the date of the concert, the location of the concert, and perhaps a graphic associated with the artist or concert. In addition, the Near You section 459 can provide a friends indication 461 that identifies those friends of the particular user that the system knows are going to the same concert. In this example, the friends indication 461 denotes that “2 friends going”. Still further, the Near You section 459 can provide a user control 462 (e.g., “Tickets” button) that facilitates purchase of tickets to the particular concert.

The concerts section 458 can also include an “On Tour” section 463 where concerts our tour that may be of interest to the particular user. The one or more concerts identified in the On Tour section 463 can be determines by a server, such as the central server 102 illustrated in FIG. 1. The one or more concerts identified can be selected based on user interest (media profile, collection or usage), friends/followed users attending or liking, geographical, etc. As illustrated in FIG. 4, the On Tour section 463 indicates that there is an upcoming concert of likely interest to the user. Concert information 464 can be provided in the On Tour section 463 to describe the particular concert. For example, the concert information 464 can include name of the artist, the date of the concert, the location of the concert, and perhaps a graphic associated with the artist or concert. In addition, the On Tour section 463 can provide a friends indication 465 that identifies those friends of the particular user that the system knows are going to the same concert. In this example, the friends indication 465 denotes that “2 friends going”. Still further, the On Tour section 463 can provide a user control 466 (e.g., “Tickets” button) that facilitates purchase of tickets to the particular concert.

The connection page 400 can also include a “Recommend You Follow” section 467. The Recommend You Follow section 467 can identify those one or more other users that the system recommends the user, i.e., John, might want to follow. Specifically, the system recognizes categories of users, including artists and people. The Recommend You Follow section 467 can include an artist subsection 468 where one or more artists that are recommended can be identified. For a given artist being recommended, the artist subsection 468 can provide descriptive information 469 for the recommended artist. In this example, the descriptive information 469 can include the name of the artist and a representative image for the artist. The system can enable an artist to have a user page, or profile, that specifies the name and representative image for the artist. The artist subsection 468 can also provide a followers indication 470 that indicates a number of user presently following the recommended artist.

The Recommend You Follow section 467 can also include a people subsection 471 where one or more people that are recommended can be identified. For a first given person being recommended, the people subsection 471 can provide descriptive information 472 for the recommended person. In this example, the descriptive information 472 can include the name of the person and a representative image for the person. The system can enable a person to have a user page, or profile, that specifies the name, media likes, “about” information, and/or representative image for the person. The people subsection 471 can also provide a “friends in common” indication 473 that indicates a number of friends that the user, i.e., John, has in common with the recommended person. Similarly, for a second given person being recommended, the people subsection 471 can provide descriptive information 474 for the recommended person. In this example, the descriptive information 474 can include the name of the person and a representative image for the person. The people subsection 471 can also provide a “friends in common” indication 475 that indicates a number of friends that the user, i.e., John, has in common with the recommended person.

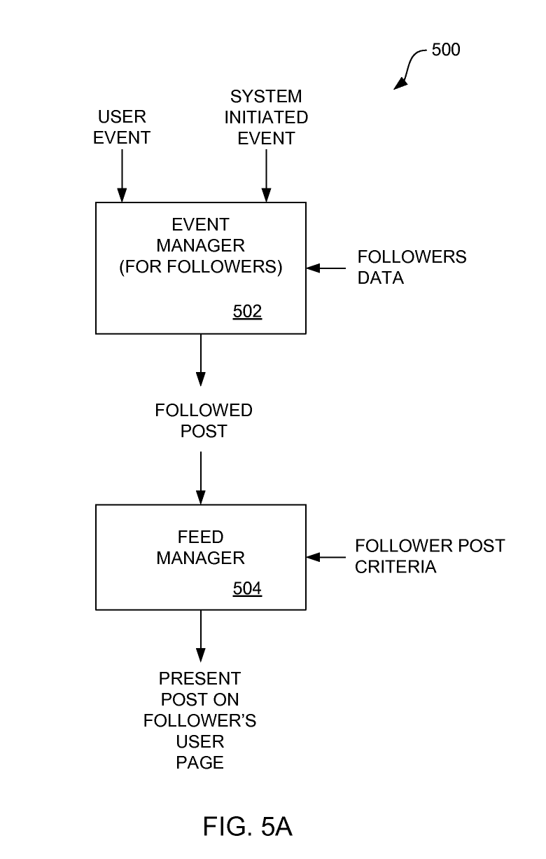

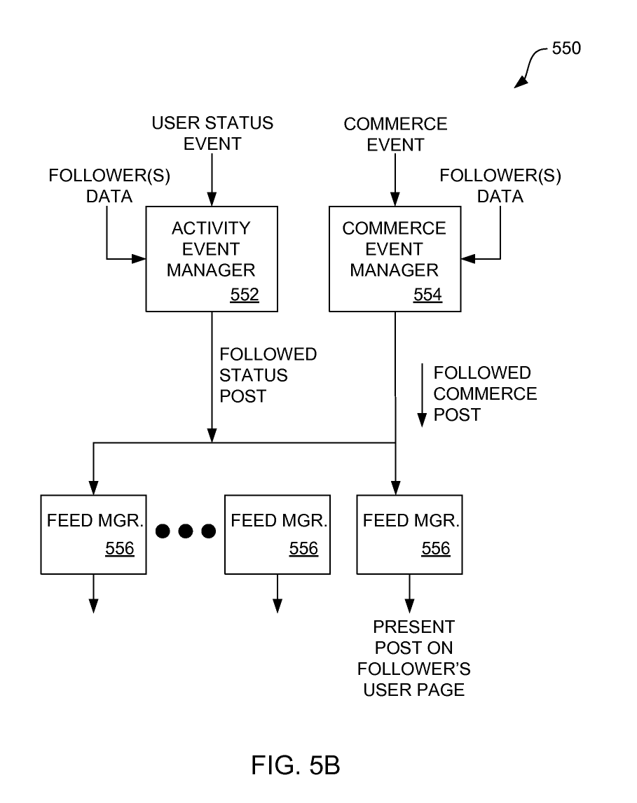

FIG. 5A is a block diagram of an event processing system 500 according to one embodiment. The event processing system 500 can include an event manager 502. The event manager 502 receives incoming events associated with a particular user. The event manager 502 can produce a followed post that can be supplied to one or more data followers. The one more data followers are users of the system that have elected to follow the particular user. The incoming events being received at the event manager 502 can include user initiated events and/or system initiated events. For example, a user initiated and is an event that is initiated by the user, such as when a user posts their status in their activity fee. As an example, a system initiated the event is an event that is initiated by the system. One example of an event initiated by the system is referred to as a commerce event, such as when the particular user purchases of products, typically via the system. Accordingly, the event manager 502 produces one or more followed post that are supplied to one or more data followers. The event manager 502 can receive followers data that identifies the one or more data followers for the events associated with the particular user.

The event processing system 500 can also include a feed manager 504 that is associated with a representative follower. In other words, in one environment, each follower of the particular user will have an associated feed manager 504. The feed manager 504 receives the followed post from the event manager 504. However, the feed manager 504 can serve to restrict the quantity of incoming posts that are presented to the representative follower. In particular, the feed manager 504 can receive follower criteria. The follower criteria is criteria that can be used by the feed manager 504 to restrict, limit or filter the incoming followed post. The follower criteria can be automatically determined by the system, set by user selections, or some combination thereof. Those of the followed post that the feed manager 504 permits to be delivered to the representative follower can be supplied by the feed manager 504 to a follower's user page where the followed post can be presented. For example, followed post can be presented in the follower's user page in an activity feed.

FIG. 5B is a block diagram of an event processing system 550 according to another embodiment. The event processing system 550 includes an activity event manager 552 that receives user status events from a particular user. The event processing system 550 also includes a commerce event manager 554 that receives commerce events from the particular user. The activity event manager 552 determines one or more followers that are to receive a followed status post concerning the particular user. The activity event manager 552 can receive follower's data that identifies one or more users that are following the particular user. The followed status post from the activity event manager 552 is directed to one or more feed managers 556. In this environment, each of the different users can utilize a different one on the feed managers 556. Hence, the followed status post from the activity event manager 552 can be delivered to the appropriate one or more of the feed managers 556 corresponding to those of the followers of the particular user.

The one or more feed managers 556 can process the incoming posts that it receives. For example, the feed manager 556 can receive a followed status post from the activity event manager 552 and can receive followed commerce post from the commerce event manager 554. Each of the feed managers 556 can separately evaluate whether to present a post on the corresponding follower's user page. That is, for a given incoming posts, the feed manager 556 can evaluate whether the post should be presented on the follower's user page. The follower criteria for the corresponding user can be utilized by the feed manager 556 make a intelligent decision on whether or not to present an incoming post on the follower's user page. The post, if presented on the follower's user page, can for example be presented as indicated in the activity region 401, such as recent activity 402, 413, 428 or 444, such as illustrated in FIG. 4.

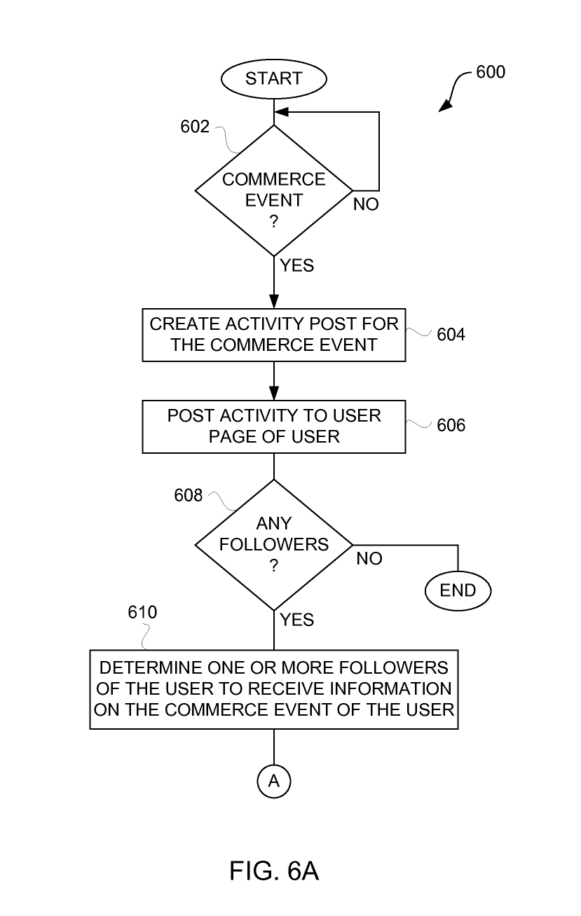

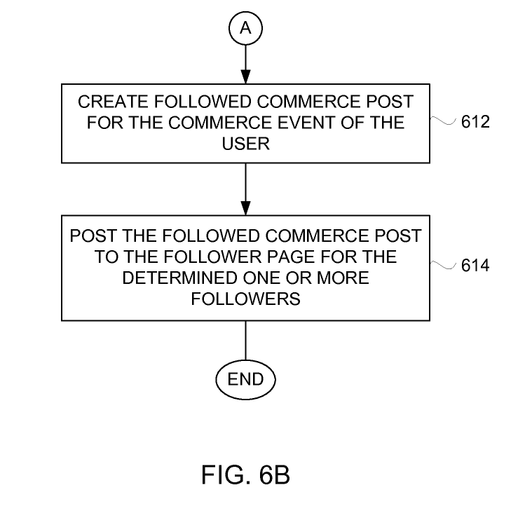

FIGS. 6A and 6B are flow diagrams of a commerce posting process 600 according to one embodiment. The commerce posting process 600 can, for example, be performed by a server, such as the central server 102 illustrated in FIG. 1.

The commerce posting process 600 can begin with a decision 602 that determines whether a commerce event has been received. The commerce event is associated with a user. Typically, the commerce event results from a purchase, namely, an online purchase, of a product by the user. The product can be a digital product, such as a digital media asset or digital program, that can be delivered electronically (e.g., downloaded) or a physical product that can be delivered by courier (e.g., Federal Express, Universal Parcel Service, etc.). When the decision 602 determines that a commerce event has not been received, the commerce posting process 600 can await such an event. Once the decision 602 determines that a commerce event for the user has been received, an activity post for the commerce event can be created 604. The activity post can include at least a textual message explaining the purchase by the user. In one implementation, the activity post is computer generated (e.g., by the server) without assistance from the user (i.e., system generated). In another implementation, the activity post is partially computer generated and the user contributes to the activity post. Besides a textual message, the activity post can also include a graphical component, such as an image of the product that has been purchased. After the activity post has been created 604, the activity post can be posted 606 to a user page of the user.

Following posting 606 of the activity post, a decision 608 can determine whether there are any followers of the user. Typically, a follower of the user decides to follow the user to receive activity posts associated with the user. Often, the user will have a user page and any followers will also have a user page. If the decision 608 determines that there are no followers of the user, the commerce posting process 600 can end. However, on the other hand, if the decision 608 determines that there are followers of the user, one or more followers of the user that are to receive information concerning the commerce event can be determined 610. Here, in this embodiment, the information concerning the commerce event is provides as a post in an activity feed of the one or more followers. More specifically, a followed commerce post can be created 612 for the commerce event of the user. In one embodiment, creation 612 of the commerce post can be by the server (e.g., computer generated).

The followed commerce post can then be posted 614 to the follower page for the determined one or more followers. In one implementation, each of the one or more followers can receive the same followed commerce post. In another implementation, the one or more followers can receive different followed commerce posts. Nevertheless, the followed commerce post will be posted 614 to all, some or none of the one more followers for the user. After the followed commerce post has been posted 614, the commerce posting process 600 can end.

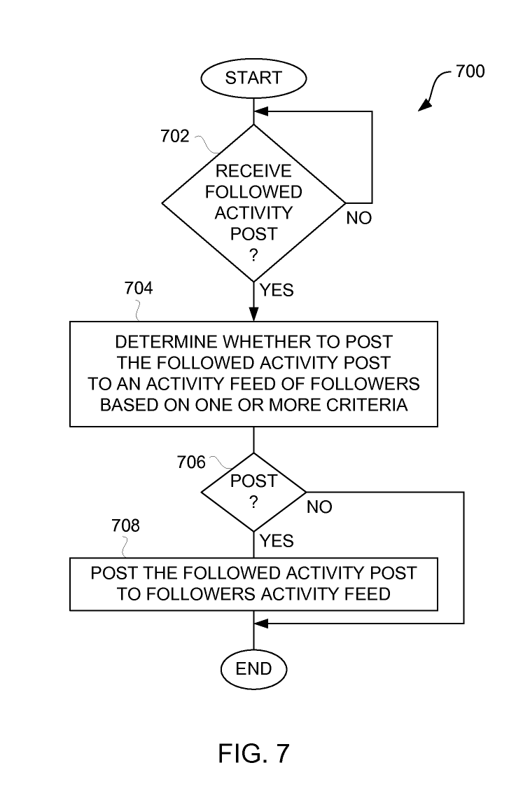

FIG. 7 is a flow diagram of a followed activity posting process 700 according to one embodiment. The followed activity posting process 700 can, for example, be associated with processing corresponding to block 610 illustrated in FIG. 6A.

The followed activity posting process 700 can begin with a decision 702 that determines whether a followed activity post has been received. When the decision 702 determines that a followed activity post has not been received, the followed activity posting process 700 can await receipt of a followed activity post. Alternatively, when the decision 702 determines that a followed activity post has been received, the followed activity posting process 700 can determine 704 whether to post the followed activity post to an activity feed of one or more of the followers based on one or more criteria. A decision 706 can then determine whether the followed activity post is to be posted to one or more of the followers. When the decision 706 determines that the followed activity post is to be posted, then the followed activity post can be posted 708 to the activity feed of each of the one or more followers that has been determined 704 to receive the feed. Following block 708, as well as following the decision 706 when the followed activity post is not to be posted, the followed activity posting process 700 can end.

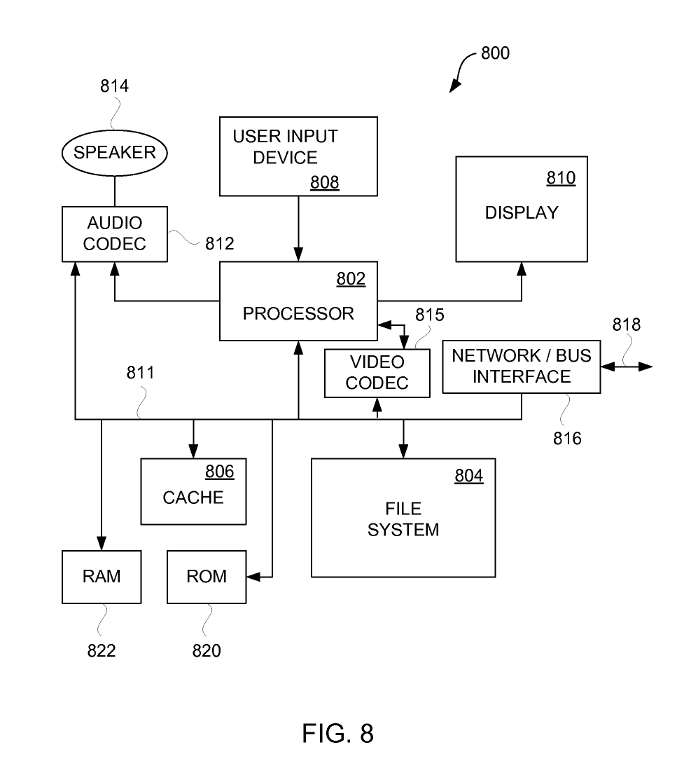

FIG. 8 illustrates a block diagram of a computing device 800 according to one embodiment. The computing device 800 can represent circuitry of a representative computing device (e.g., user or follower computer device), central server, or online store (e.g., online media server) described and illustrated in FIG. 1. The computing devive can be designed to primarily stationary or can be portable.

The computing device 800 includes a processor 802 that pertains to a microprocessor or controller for controlling the overall operation of the computing device 800. The computing device 800 stores media data pertaining to media items in a file system 804 and a cache 806. The file system 804 is, typically, semiconductor memory (e.g., Flash memory) and/or one or more storage disks. The file system 804 typically provides high capacity storage capability for the computing device 800. However, since the access time to the file system 804 can be relatively slow, the computing device 800 can also include the cache 806. The cache 806 is, for example, Random-Access Memory (RAM). The relative access time to the cache 806 is typically shorter than for the file system 804. However, the cache 806 does not have the large storage capacity of the file system 804. The computing device 800 also includes a RAM 820 and a Read-Only Memory (ROM) 822. The ROM 822 can store programs, utilities or processes to be executed in a non-volatile manner. The RAM 820 provides volatile data storage, such as for the cache 806.

The computing device 800 may also include a user input device 808 that allows a user of the computing device 800 to interact with the computing device 800. For example, the user input device 808 can take a variety of forms, such as a button, keypad, dial, touch-sensitive surface, etc. Still further, the computing device 800 includes a display 810 (screen display) that can be controlled by the processor 802 to display information to the user. A data bus 811 can facilitate data transfer between at least the file system 804, the cache 806, the processor 802, an audio coder/decoder (CODEC) 812 and/or a video CODEC 815.

In one embodiment, for example, if the computing device 800 is a media player, the computing device 800 may store a plurality of media items (e.g., songs, videos, podcasts, etc.) in the file system 804. When a user desires to have the computing device play a particular media item, a list of available media items is displayed on the display 810. Then, using the user input device 808, a user can select one of the available media items. The processor 802, upon receiving a selection of a particular media item, supplies the media data to one or more appropriate output devices. If the particular media item is encrypted, the particular media item is first decrypted as noted above, which could involve one or more layers of encryption. As an example, for audio output, the processor 802 can supply the media data (e.g., audio file) for the particular media item to the audio CODEC 812. The audio CODEC 812 can then produce analog output signals for a speaker 814. The speaker 814 can be a speaker internal to the computing device 800 or external to the computing device 800. For example, headphones or earphones that connect to the computing device 800 would be considered an external speaker. As another example, for video output, the processor 802 can supply the media data (e.g., video file) for the particular media item to the video CODEC 815. The video CODEC 815 can then produce output signals for the display 810 and/or the speaker 814.

The computing device 800 also includes a network/bus interface 816 that couples to a data link 818. The data link 818 allows the computing device 800 to couple to another device (e.g., a host computer, a power source, or an accessory device). The data link 818 can be provided over a wired connection or a wireless connection. In the case of a wireless connection, the network/bus interface 816 can include a wireless transceiver.

This application also references U.S. Provisional Patent Application No. 61/378,817, filed Aug. 31, 2010, entitled “CLASSIFICATION AND STATUS OF USERS OF NETWORKING AND SOCIAL ACTIVITY SYSTEMS,” and incorporated herein by reference for all purposes.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for managing distribution of user activity over a data network, the method comprising:
processing a commerce transaction with an online store for a first user;
creating an activity post based on the commerce transaction;
posting the activity post to an online user page for the first user;
determining one or more followers of the first user that are to be made aware of the commerce transaction of the first user;
creating a followed commerce post for the commerce event of the user; and
posting the followed commerce post to the follower page for at least one of the determined one or more followers.

2. A method as recited in claim 1, wherein the followed commerce post includes a user control that facilitates an electronic commerce purchased.

3. A method as recited in claim 1,
wherein the commerce transaction involves purchase of an electronic product via an online store, and
wherein the followed commerce post includes a user control that facilitates an electronic commerce purchase for the electronic product.

4. A method as recited in claim 3, wherein the user control is a link to a page of the online store where the electronic product can be purchased.

5. A method as recited in claim 1, wherein, for each of the one or more followers, the determining of the one or more followers of the first user that are to be made aware of the commerce transaction of the first user comprises:
obtaining follower criteria pertaining to the corresponding one of the one or more followers; and
determining whether the corresponding one of the one or more followers is to be made aware of the commerce transaction of the first user based on the follower criteria.

6. A method as recited in claim 5, wherein the follower criteria includes at least one user preference.

7. A method as recited in claim 5, wherein the follower criteria is at least partially associated with media collection information or media usage information associated with the first user.

8. A method as recited in claim 1, wherein, for each of the one or more followers, the determining of the one or more followers of the first user that are to be made aware of the commerce transaction of the first user comprises:
obtaining a classification pertaining to the corresponding one of the one or more followers; and
determining whether the corresponding one of the one or more followers is to be made aware of the commerce transaction of the first user based on the classification.

9. A method as recited in claim 8, wherein the classifications include at least the classifications of: user, artist and expert.

10. A method as recited in claim 1, wherein, for each of the one or more followers, the determining of the one or more followers of the first user that are to be made aware of the commerce transaction of the first user comprises:
obtaining a classification pertaining to the first user; and
determining whether the corresponding one of the one or more followers is to be made aware of the commerce transaction of the first user based on the classification pertaining to the first user.

11. A method as recited in claim 10, wherein the classifications include at least the classifications of: user, artist and expert.

12. An online activity monitoring and distribution system, comprising:
a plurality of users with each user having at least one electronic page, where one or more of the users follow one or more other of the users; and
at least one server computer configured to provide electronic pages for each of the users, the at least one server computer supporting an activity event manager to manage activity of the users,
wherein the activity event manager is configured to receive activity events for the users, and
wherein, for each the activity events being received regarding a particular user, the activity event manager (i) determines those other users that respectively follow the particular user, (ii) forms a followed activity post based on the activity event received regarding the particular user, and (iii) sends the followed activity post to the electronic pages corresponding to the other users that respectively follow the particular user.

13. An online activity monitoring and distribution system as recited in claim 12, wherein the activity events include at least one user-initiated event and at least one system-initiated event.

14. An online activity monitoring and distribution system as recited in claim 12, wherein the activity events include a system-initiated event, and wherein the system-initiated event pertains to an online commerce purchase by or for the particular user.

15. An online activity monitoring and distribution system as recited in claim 12, wherein the activity event manager is configured to send the followed activity post to the electronic pages corresponding to the other users that that respectively follow the particular user.

16. An online activity monitoring and distribution system as recited in claim 12, wherein said at least one server computer further supports one or more feed managers to manage feeds of the users.

17. An online activity monitoring and distribution system as recited in claim 16, wherein the feed manager corresponding to each of the other users that respectively follow the particular user is configured to manage on or more posts to an activity feed provided within the electronic page for the particular user.

18. An online activity monitoring and distribution system as recited in claim 16, wherein the activity event manager is configured to send the followed activity post to the one or more feed managers corresponding to the other users that respectively follow the particular user.

19. An online activity monitoring and distribution system as recited in claim 12, wherein the one or more feed managers each evaluate, based on follower post criteria, whether to provide the followed activity post to the electronic page corresponding to the other users that respectively follow the particular user.

20. An online activity monitoring and distribution system as recited in claim 12,
wherein the activity event manager is configured to evaluate whether to send the followed activity post to the one or more feed managers corresponding to the other users that that respectively follow the particular user, and
wherein the one or more feed managers each evaluate whether to provide the followed activity post to the electronic page corresponding to the other user that that respectively follow the particular user.

21. A computer readable medium including at least computer program code tangibly stored thereon for managing distribution of user activity over a data network, the computer readable medium comprising:
computer program code for detecting an electronic commerce transaction for a product or service for a first user;
computer program code for determining at least one follower of the first user that is to be made aware of the commerce transaction of the first user;
computer program code for creating a followed commerce post for the commerce transaction of the user; and
computer program code for posting the followed commerce post to the follower page for the determined at least one follower.

22. A computer readable as recited in claim 21,
wherein the commerce transaction involves purchase of an electronic product via an online store, and
wherein the followed commerce post includes a user control that facilitates an electronic commerce purchase for the electronic product.

23. A method as recited in claim 22, wherein the user control is a link to a page of the online store where the electronic product can be purchased.

24. A method as recited in claim 21, wherein, for each of the at least one follower, the determining of the at least one follower of the first user that are to be made aware of the commerce transaction of the first user comprises:
obtaining follower criteria pertaining to the at least one follower; and
determining whether the at least one follower is to be made aware of the commerce transaction of the first user based on the follower criteria.

25. A method as recited in claim 21, wherein, for the at least one follower, the determining of the at least one follower of the first user that is to be made aware of the commerce transaction of the first user comprises:
obtaining a classification pertaining to the at least one follower; and
determining whether the at least one follower is to be made aware of the commerce transaction of the first user based on the classification.
